(19) United States
(12) Patent Application Publication
(10) Pub. No.: US 2023/0368089 A1
(43) Pub. Date: Nov. 16, 2023

(54) SYSTEMS AND/OR METHODS FOR CONFIGURING AND/OR CONDUCTING SCENARIOS FOR PROVIDING TRAINING EXERCISES AND/OR TESTING EQUIPMENT CAPABILITIES AND/OR LIMITATIONS

(71) Applicant: KNOWMADICS, INC., Herndon, VA (US)

(72) Inventors: Jeremy Michael Jones, Southern Pines, NC (US); David West Reinhard, Odessa, FL (US); Sean James Kelly, Wakefield, MA (US); Josh Anson Fultz, Sanford, NC (US); Claire Ostrum, Leesburg, VA (US); Sandra Sutton, Weatherford, TX (US)

(21) Appl. No.: 18/316,139

(22) Filed: May 11, 2023

Related U.S. Application Data
(60) Provisional application No. 63/340,506, filed on May 11, 2022.

(51) Int. Cl. G06Q 10/0631

(52) U.S. Cl. CPC G06Q 10/06311; G06Q 10/06312

(57) ABSTRACT

Certain examples of the present technology provide a process providing realistic scenario based full mission profile support for full spectrum technical operations. The technical operations include one or more of Exercise Support and Training, Test and Evaluation Assessments and Events, and Technical Counter Surveillance Measures (TSCM) Assessments. The process may allow for personnel to provide complete exercise support packages, role player management, test plans, TSCM plans, and have the ability to quickly adapt to changing performance requirements on the fly based on the required input into the system in the beginning stages of the process.

This application claims priority to U.S. Provisional Application No. 63/340,506 filed May 11, 2022, the entire contents of each of which are hereby incorporated by reference.

### TECHNICAL FIELD

Certain examples of the present technology described herein relate to systems and/or method for configuring and conducting scenarios for training and testing. In certain examples, the present technology relates to techniques for providing training and hands-on exercises for multiple training related methodologies and/or equipment in order to prepare personnel (e.g., analysts and operators) and/or test equipment. The training and exercises can be tailored to support tactics, techniques and procedures for specific programs, protocol applications and/or equipment to meet operational requirements.

### BACKGROUND AND SUMMARY

Realistic exercise and scenarios for personnel and equipment is needed to certify personnel and/or equipment. Existing approaches provide companies that perform testing of equipment that needs to be certified. However, this approach is costly and time consuming because the equipment needs to be reevaluated with changes in technology and/or operating environment.

Certain example embodiments help address the above-described and/or other concerns. For example, certain example embodiments help improve testing of equipment by providing for a realistic exercise and scenarios for tech teams to conduct full-spectrum, technical targeting operations in different environment.

The features, aspects, advantages, and example embodiments described herein may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a flowchart showing an overall processing flow according to certain example of the present technology;

FIG. 2 is a flowchart showing operations that may be performed in the requirements gathering phase shown in FIG. 1 in accordance with certain example embodiments;

FIG. 3 is a flowchart showing operations that may be performed in the analysis and administration phase shown in FIG. 1 in accordance with certain example embodiments;

FIG. 4 is a flowchart showing operations that may be performed in the pre-development site survey phase shown in FIG. 1 in accordance with certain example embodiments;

FIG. 5 is a flowchart showing operations that may be performed in the task organization and technical development phase shown in FIG. 1 in accordance with certain example embodiments;

FIG. 6 is a flowchart showing operations that may be performed in the operational execution phase shown in FIG. 1 in accordance with certain example embodiments;

FIG. 7 is a flowchart showing operations that may be performed in the review and reporting phase shown in FIG. 1 in accordance with certain example embodiments;

FIG. 8 is an example diagram of process flow phases and tasks that can be associated with each phase;

FIGS. 9A-9G illustrate an Example Technical Counter Surveillance Measures (TSCM) report for a customer accordance with certain example embodiments; and

FIGS. 10A-10H illustrate an Environmental Test Plan according with certain example embodiments.

### DETAILED DESCRIPTION

Certain examples of the present technology relate to providing systems and/or methods providing a realistic exercise and scenarios for tech teams to conduct full-spectrum, technical targeting operations in an urban environment. Example exercises may include targeting operations against one or more communication protocols (e.g., Cellular, WiFi and Bluetooth protocols), differing weather conditions, environments and/or presence or absence of certain conflicting or supporting equipment. Activities can be integrated into field problems for both active and/or passive Electronic Warfare (EW), Cryptologic Warfare (CW), Technical Surveillance Equipment (TSE), Cyber, Unmanned Maritime Systems (UMS) and Clandestine Methods Of Entry (CMOE) operations. Examples of the present technology can provide a multitude of challenging field problems integrating different types of devices and/or communicating over same and different networks. The networks may be isolated from or connected to other public and/or private networks. The devices may include smart devices, personal computers, routers, wireless and/or wired hotspots, cellular devices, and/or personal Bluetooth devices.

Certain examples of the present technology may provide a scenario in which individual or team can build and identify specific operations (e.g., an external maritime operations cell) within a discrete environment. The environment may be provided utilizing a plurality of integrated capabilities and toolsets available to the individual or team. The scenario may be driven by different levels of technical equipment capabilities and may utilize baselines (e.g., a counter-Intelligence baseline) to execute Tactics, Techniques, and Procedures (TTPs) with taskable sources such as Intelligence Information Reports (IIRs) and Call Data Records (CDRs). The environment variables may be entered into an aggregation platform configured to aggregate data (e.g., from different devices and/or sources), analyze the data, provide user feedback and/or after-action performance, which may include 360° Aware® platform (e.g., for visualization of the overall scenario) and/or system described in U.S. Pat. Application 17/843,515. According to some examples, the environment variables may be entered into one or more devices and/or system(s) described in U.S. Pat. Application 17/843,515, which is hereby incorporated by reference.

Certain examples of the present technology provide exercise events that will drive the need for passive operations (mobile and static); provide daily passive content to support follow on daily tasking as required; and support identification finding operations through passive and active technical operations (vehicle and man-packable operations). Events may be driven and progressed forward throughout the exercise by the technical equipment and capabilities available to support the individual or team operations from the command.

According to certain examples of the present technology, during the course of the exercise and scenario, training exercises on passive and active operations for the protocols encountered may be executed. Execution of these exercises may allow personnel to demonstrate their knowledge with equipment and Tactics, Techniques, and Procedures in support of command requirements.

Sample scenarios may incorporate and/or provide a vulnerable closed-loop network for conducting cyber exploitation for in the air, maritime and/or land-based operations. For example, in a land-based operation a plurality of small home small office (SOHO) wireless access points throughout the scenario environment for a predefined cyberspace operations. These locations and devices may be captured and visualized in an aggregation platform. The aggregation platform may be used to show the relation of exercise participants and mobile and static targets within the scenario. According to some examples, locations and devices may be captured and visualized in one or more devices and/or system(s) described in U.S. Pat. Application 17/843,515. The visualization may include relation of exercise participants and mobile and static targets within the scenario.

According to certain examples of the present technology, throughout the exercise and scenario devices and/or personnel (e.g., using device) may collect, analyze and prosecute multi-mode circuit and packet switched data, IP data, & DPTT data (ISO Indications & Warning requirements) to support a scenario-based model of events. Content gained from these efforts can be utilized to support the overall exercise goal of identifying an external maritime operations cell in order to prevent notional substantial event(s).

According to certain examples of the present technology, the systems and methods may provide a full exercise and scenario overview brief as needed with supporting documentation. Documentation may include daily timeline of events, listed and mapped locations of all planned role player activity, list of role players and designated protocols, and/or general description of talking points and daily role player activities. One or more or all these mapped locations may be visualized in an aggregation platform for viewing and situation awareness throughout the scenario. Additionally, the aggregation platform may be used to generate common stop analysis charts based on role player tracking activity within the system. According to some examples, one or more or all of the mapped locations may be visualized in one or more devices and/or system(s) described in U.S. Pat. Application 17/843,515. One or more devices and/or system(s) described in U.S. Pat. Application 17/843,515 may be used to generate common stop analysis charts based on role player tracking activity within the system.

In some examples the scenario environment may include target devices (e.g., smart phones, tablets, laptops, non-standard communications, Red Team electronic warfare, and/or smart devices to be used for targeting operations during the exercise and training evolutions) disposed at different location, role players provided at different locations, one or more on-site controllers to provide command and control over the scenario as well as training and mentorship for personnel as needed on operations during daily iterations, one or more operational safe site for a person or team, one or more mobile nodes (e.g., mobile hotspots) disposed at different location and configured to provide private communication (with file sharing, instant messaging, anonymous research) between team members in the same team and/or between different teams, and/or one or more repeaters (e.g., PTT/DPTT repeater) capable of operating in different band (e.g., the 70 cm and 2 m bands). An aggregation platform may be used to show relational activity and engagement between target sites, role players, and/or exercise participants throughout the scenario. According to some examples, relational activity and engagement between target sites, role players, and/or exercise participants throughout the scenario may be shown using one or more devices and/or system(s) described in U.S. Pat. Application 17/843,515.

Some of the role players may be associated with target devices. In some examples, the role players may provide professional feedback on student’s activities, disposition, demeanor, and technical skills. The onsite controller may be configured to observe and provide daily feedback to customer command leadership and personnel in order to better adjust the exercise tempo and progression and maximize training value. The operation safe site may provide a secure stating area for secure storage and team operational planning and preparations.

One or more devices of the system may support command requirements for Kitefin and/or Marauder networked integration into scenario events and/or a vulnerable closed-loop network for conducting cyber exploitation. In some examples, one or more of the following requirements may be included: Network devices will be connected to CW internal exercise network (XNET) equipment; Network will utilize a VPN with Suite B encryption standards; Internet backhaul (Verizon/AT&T Mobile 5G/4G mobile hotspots) will provide internet backhaul to connect to XNET; Network will contain a vulnerable dual-NIC Windows device to be dual-homed to an internal secondary network containing data in directories for intel and/or network documentation; Network will contain multiple vulnerable Windows devices behind the dual-NIC Windows device; Network will contain a vulnerable Windows or Linux File Share Server; Network will contain multiple Android and/or iPhone mobile handsets; Network will contain multiple TCP/IP based camera systems; and/or Network will contain multiple small home small office (SOHO) wireless access points and security appliances.

Certain examples of the present technology provide for products including: Exercise Support Packages and Plans; Comprehensive Post Operation Review and Report; Technical Test, Evaluation, and Assessment Plans; Comprehensive Test, Evaluation and Assessment Report; Technical Counter Surveillance Measures Assessment Plans; and/or Technical Counter Surveillance Measures Assessment Report. An aggregation platform may provide common stop reports in relation to role players and their pattern of life movements throughout the scenario. According to some examples, stop reports in relation to role players and their pattern of life movements throughout the scenario may be provided by one or more devices and/or system(s) described in U.S. Pat. Application 17/843,515.

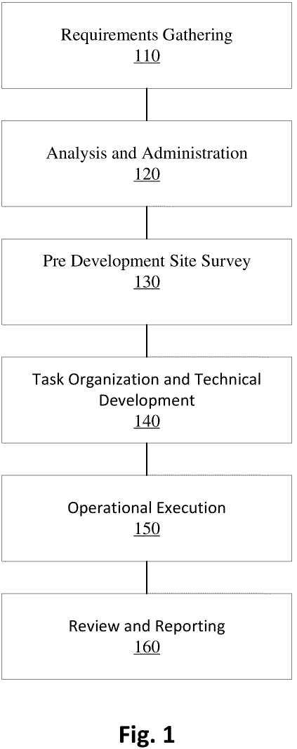

FIG. 1 is a flowchart showing an overall processing flow according to certain example embodiments. Requirements are gathered in step 110. Analysis and administration is performed in step 120. Pre development site survey is performed in step 130. Task organization and technical developed in step 140. Operational execution is performed in step 150. Review and reporting is performed in step 160. One or more of the steps show in FIG. 1 may be omitted, repeated and/or provided in a different order according to some examples of the present technology.

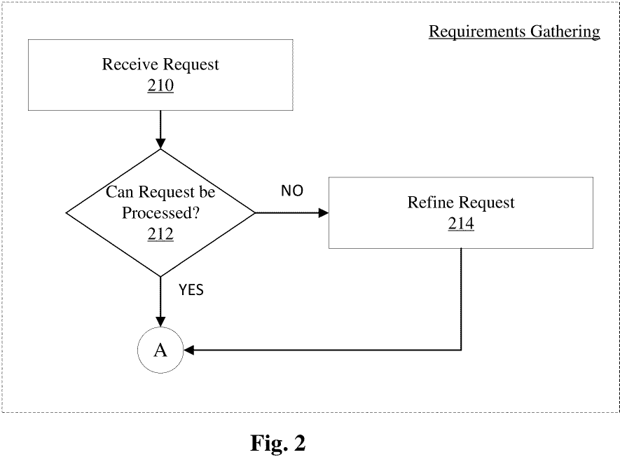

FIG. 2 illustrates operations that may be performed in the requirements gathering phase (step 110) shown in FIG. 1. In step 210, initial requirements are received. The requirements may be received from a customer, a location identified by the customer, and/or location storing requirements associated with the customer. The requirements may be received for one or more devices and/or may include a broad scope of requirements. The requirements may be retrieved from a local and/or a remote database. In some examples, the requirements may include cost limits, performance expectations for each the device, conditions under which each device is to be tested, and/or timeline. In some examples, the cost, the performance expectations, and/or testing conditions may be provided for each device and may be different for each device or different for some of the devices.

In step 214, a determination is made as to whether the request can be processed. The determination may be made based on the initial requirements. In some examples, the determination may be made based on the initial requirements, capabilities of the entity providing the service, cost of providing the service based on the initial requirement and/or profit from providing the service based on the initial requirement. The capabilities of the entity may include available time, needed effort, available manpower, and/or needed and available expertise.

If the determination is made that the request cannot be processed (NO in step 212), refinement to the initial request can be performed in step 214. Refining the initial request can include modifying one or more of cost, timeline, manpower. Refining the initial request may include performing expectation management, where a return is made to the initial request and refining a solution that works for the customer (e.g., requesting entity) and the entity providing the service. In some examples, the initial request may be refined multiple times based on multiple refined requests from the customer and/or information (e.g., capabilities) provided by the entity providing the service.

If the determination is made that the request can be processed (YES in step 212), the process can proceed to analysis and administration phase (step 120 in FIG. 1).

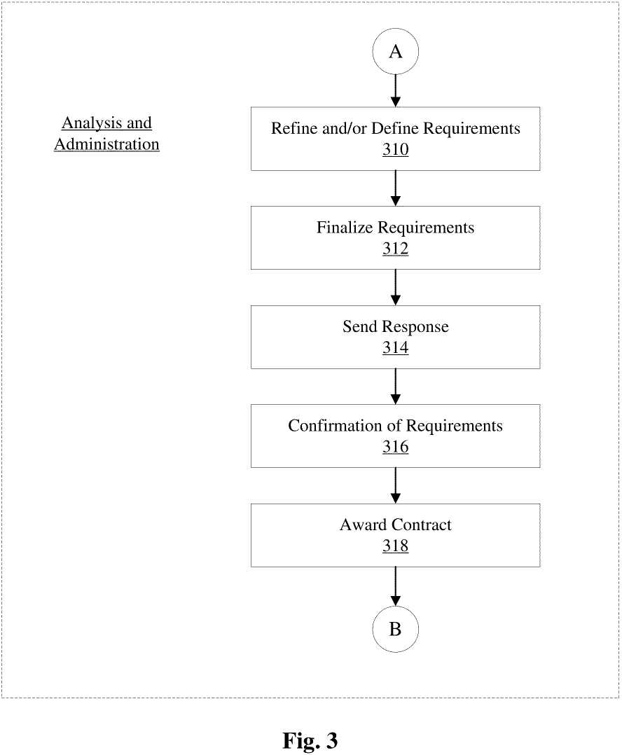

FIG. 3 illustrates operations that may be performed in the analysis and administration phase (step 120) shown in FIG. 1. In step 310, the requirements are refined and/or defined. The initial broad requirements may be defined to provide detailed requirements in step 310. Step 310 may include intimate discussions with customer at all levels on technologies, Tactics, Techniques and Procedures (TTPs), capabilities, Mission-Essential Task Lists (METLs), Tasks, Training Objectives, etc.

In step 312, the requirements are finalized. Finalizing the requirements may include documenting the finalized requirements to provide a Statement of Objectives (SOO). The finalized requirements may sent to a remote device and/or output on a display device (e.g., via a user interface). The SOO may be a customer / a ghost written SOO that is customer drafted, sent to a project manager (PM) and/or contracting officer (KO) for approvals, and then out to vendor (Key Management Infrastructure (KMI)). In addition or alternatively, finalizing the requirements may include assisting and/or providing sole source justifications (SSJ) working pending training and/or exercise requirements.

In step 314, a response is sent. The response may be sent to the customer (e.g., a device and/or remove location associated with the customer). In some examples, the response may include a quote for the requested service. The quote may mirror the SOO and meet one or more line items listed throughout the requirements. In some examples, the quote may meet every line item listed throughout the requirements. Providing the quote at this stage may allow for the pricing to be already expected and/or known so that the customer is not sticker shocked. The quote may be generated based on previously used quotes and/or approved quotes stored in a database of the provider of the service and/or a database provided by the customer, and/or database providing standard fees and/or cost set by a government organization or contractor or a standards organization.

In step 316, confirmation of requirements is obtained. Step 316 may include discussions and/or responses with PM and/or KP level to ensure that the customer requirements are met and/or that the pricing is standardized and/or meets requirements (legal and/or customers). In some examples, one or more responses from one or more sources (e.g., devices or organizations) may be received confirming the customer requirements are met and/or that the pricing is standardized and/or meets requirements (legal and/or customers).

In step 318, the contract is awarded. In step 318, the entity may receive an awarded contract and the awarded contacted may be accepted by the entity providing the service. A template with information relating to the contract may be automatically populated and transmitted to the customer indicating that the contract is awarded.

According to some examples of the present technology, back and forth from initial requirement gathering to pre-development site survey can take certain amount of time (e.g., weeks or months). During this period, team and command requirements can shift, the scope of the requirements can shift and/or changes and/or requirements in technology may occur. The system may automatically make updates to the initial requirements, detailed requirements, costs and/or proposals with the changes.

Key Management Infrastructure (KMI) may have members with some level of prior experience, real world knowledge (often operational), and understanding and ability to help customer define / outline desires to meet their real requirements. This may be one of the biggest factors of KMI successes.

KMI knowledge and understanding of having seen (while active) the same from everyone as well as having been a part of other organizations that provide “the same” level and type of training and support. The KMI may utilize trained arterial intelligence models to help participants define / outline desires to meet their real requirements.

In some examples, SOOs most often are very broad in scope and do not contain detailed and/or desired level of training or requirements. Accordingly, a preparation and planning phase may be critical with an SOO having a very broad scope to define actual requirements and providing a firm fixed price (FFP) quote to actual requirements vs a best guess price/response based on a broad scope SOO. Thus, the quote can be written for and price the real processes expected to be performed instead of guessing the cost (e.g., based on the broad scope defined in the SOO). Quotes in FFP can provide ability to respond to actual requirements vs written to meet legal requirements.

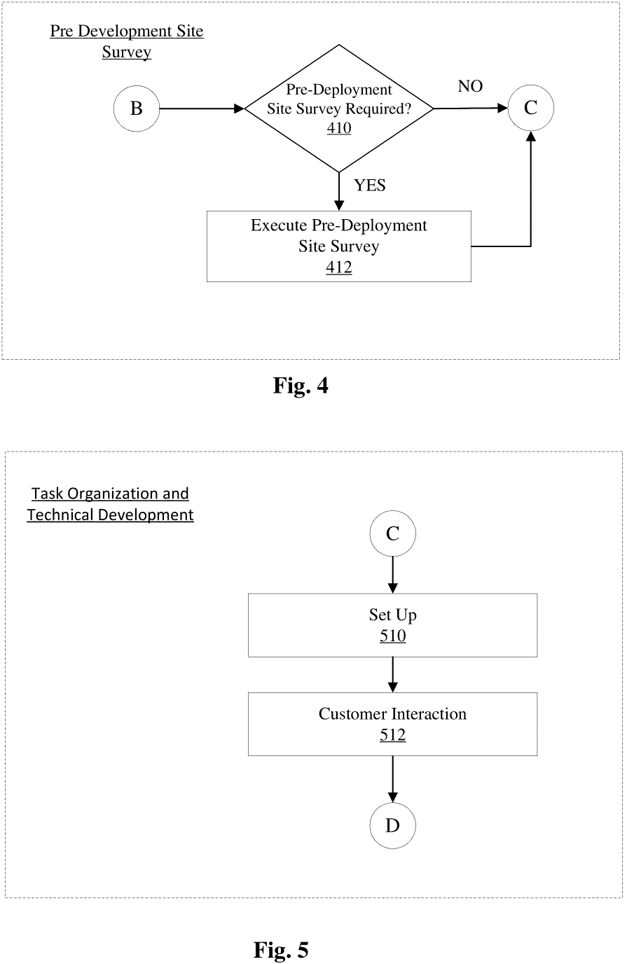

FIG. 4 illustrates operations that may be performed in the pre-development site survey phase (step 130) shown in FIG. 1. In step 410, a determination is made whether Pre Development Site Survey (PDSS) is required. If the determination is made that the PDSS is required (YES in step 410), then PDSS is executed in step 412. After executing the PDSS, task organization and technical development (step 116 shown in FIG. 1) is performed. If the determination is made that the PDSS is not required (NO in step 410), task organization and technical development (step 116 shown in FIG. 1) is performed without executing the PDSS.

FIG. 5 illustrates operations that may be performed in the task organization and technical development phase (step 140) shown in FIG. 1. Set up is performed in step 510 and customers arrive in step 512.

The set up may include the KMI arrival prior to the customer to prepare the site for the customer. Preparing the site may include role players meeting and preparing. The preparation may include indicating role players identifies, responsibilities of role players, and/or locations of all planned role player activities. The locations of the role players may be provided based the requirements provided by the customer.

The role players may include player with different responsibilities and/or expertise. In some examples, the role players may include multiple layers of requirements (e.g., low, medium and high). The role players may include one or more lead role players that can assist in generating the reports and briefing the customer leadership on the customer’s team’s performance. The lead role players may meet during the set up.

During the set up, the site is prepared for testing the performance of devices and/or customer’s team, setting up one or more wired and/or wireless networks. The set up may be performed during a predetermined time period before the customer arrival for the testing or before a predetermined time before the customer arrival for the testing. The predetermined time period and/or predetermined time may be defined by the customer requirements or may be preset by the entity providing the service. In some examples, the predetermined time may be a preset number of hours or days. In one example, the predetermined time may be at least one day prior to customer arrival (e.g., hangars) due to logistics (e.g., due to shipping). The predetermined time period may provide for a maximum time when set up is to begin to minimize the environmental changes, that may occur between setup to start of the start of the testing, affecting the results of the testing.

When the customer arrives (step 512), the steps may include, presenting an in-brief, discussing expectations and requirements, revisiting with all levels (senior / Junior personnel), adjusting requirements (which may be minor and/or which are doable within scope of contract), and/or identify new and low level requirements able to support from junior and vet through senior to incorporate if approved. During the customer interaction information in the system may be updated based on the adjusting requirements and/or identified new and low level requirements.

In some example, one or more of the minor changes that are outside of the contract scope are denied and/or one or more of the minor changes that are outside of the contract scope are approved. The decision to approve or deny the changes may be determined based on the ability to satisfy other contract requirements that may be affected by the minor changes and/or ability to stay within the cost estimates. In some example, the contract may provide guidelines for which minor changes can be approved and which changes would be denied. The determination of whether to approve or deny the changes may be made by the system based on prestored criteria (e.g., defined in the contract or outside of the contract), information about the changes, information of the role players (capabilities, availability), information about the testing environment, and/or information about the available devices (technical capabilities).

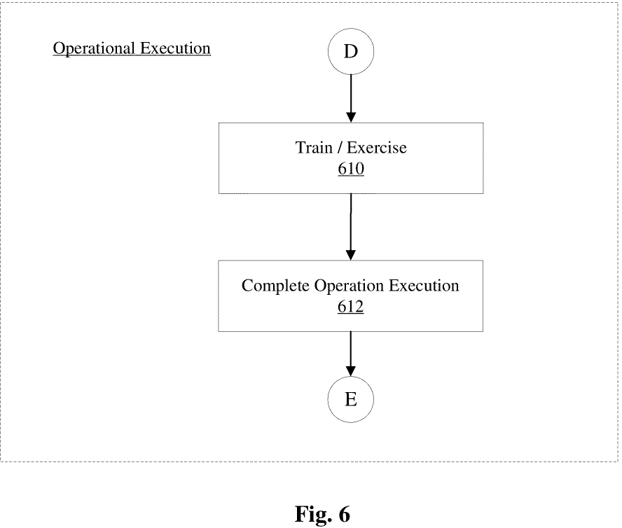

FIG. 6 illustrates operations that may be performed in the operational execution phase (step 150) shown in FIG. 1. Set up is performed in step 510 and customers arrive in step 512. The operational execution phase may include training exercise operation (step 610) and complete operation execution (step 612).

The training exercise operation (step 610), may include begin training and/or exercise plan with any updates while incorporating one or more changes. If the changes are within the scope of the contract, the changes can be incorporated based on whether they can be made, they are actual requirements, and/or whether the opportunities during to execute are doable. The changes may be built into the current (day) or future days to execute. In some examples, leadership of the entity providing the service and/or leadership of the customer may need to be made aware of and provide approval of the changes even if they are within the scope of the contract. In some example, the system may automatically approve changes meeting predefined criteria (e.g., if cost associated with change does not exceed a preset amount, additional role players are not needed, changes are not within the scope of the contract and/or if additional devices are available for the exercise)

If the changes are not within the scope of the contract, the requirements may be discussed with leadership (e.g., of the entity providing the service and/or the customer) to be addressed in future exercises or other training. Such requests and discussions may be documented for inclusion the future exercises or other training.

Completing the operation execution (step 612) may include running through the exercises and/or training to the end, while constantly changing the process to ensuring that all customer scope requirements are met and stay within the budget. Additionally, an aggregation platform may be populated with all static site and target site information as well as devices representing role players and exercise participants for command and control and analysis of scenario operations. According to some examples, the static site and target site information as well as devices representing role players and exercise participants for command and control and analysis of scenario operations may be provided to, collected by managed, and/or displayed using one or more devices and/or system(s) described in U.S. Pat. Application 17/843,515.

Running through the exercises and/or training may be performed based on the initial requirements, detailed requirements, and information received from the role players. The exercises and training may include receiving information about operations performed on devices associated with role players, and information about operations performed on devices associated with individuals being tested and/or trained. The devices associated with the role players and/or individuals being tested and/or trained may be configured to capture and provide to the system background data (e.g., metadata), information displayed on the devices, inputs received via the devices or via input devices associated with the devices, and locations and/or movement of the devices. The received information may be analyzed to determine satisfactory or non-satisfactory performance. The system may transmit instructions (e.g., tasks to be performed) to the devices associated with the role players and/or individuals being tested and/or trained based on progress of the exercise. In some example, individuals being tested and/or trained do not satisfy predetermine criteria during the exercise, the associated device may receive instructions providing assistance that are automatically generated and/or generated by an administrator of the exercise.

The system may aggregate information received from the different device during the exercise and provide a user interface providing information on progress of the exercise and information about one or more devices involved in the exercise. In some example, the system may be configured to automatically or based on user received inputs control one or more operations performed on the devices. The user interface may provide a graphical display of operations performed on the devices, information displayed on the devices, and information about the user of the device and/or the environment where the device is located (e.g., heartbeat or temperature of the user, temperature of the environment, electromagnetic interference of the environment). The collected and processed information may be used to determine whether the individuals being tested and/or trained meets predefined criteria (e.g., defined in the contract) and/or be used to rank the individuals being tested and/or trained.

FIG. 7 illustrates operations that may be performed in the review and reporting phase (step 160) shown in FIG. 1. In step 710, packing and wrapping and/or shipping is performed by the KMI and customer. In some examples, the KMI does not fully leave the area of operation (AO) until all customer are gone to support possible issues. In some examples, the review and reporting may provide a report of the testing environment satisfying the requirements and/or participants (individuals being tested and/or role players) satisfying the requirements.

In step 712, on-site debriefs are conducted. The on-side debriefs may include customer and/or team internal debriefs and/or group within KMI debriefs. The on-site debriefs may include discussing gaps and best way for KMI to report the gaps and/or customer to report the gaps. In some examples, the gaps may be written from a vendor to identify gaps to support command requirements. The gaps may identify non-satisfaction of one or more initial requirements or additional requirements determined before or during the exercise. The on-site debriefs may include providing written KMI debriefs to senior and contracting officers. The on-site debriefs may be conducted in a manner to encourage honest feedback to support customer beyond extenuating circumstances. The system may be configured to receive feedback that is associated with specific individuals (e.g., participants, role players, administrators) and/or anonymously. In some examples, some feedback may be received only anonymously.

In step 714, leadership briefs may be provided. The leadership briefs may provide a formal post operation report. The team and/or customer leads may be given opportunities to review the briefs so that the report by the KMI does not unnecessarily damage the team and/or personnel and correctly word potential gaps and/or training concerns. During the preparation and/or distribution of the leadership briefs, the Business Planning Team (BPT) may talk through full KMI process from initial to end to the command level seniors. The system may be updated based on the received feedback. Leaders may sometimes be not as involved as they think/want to be involved. Involving the leaders at this level may provide them with information needed to provide additional support to the customer and/or other potential customer in the future for other contracts. For example, the leaders of the business planning team are the ones who take Non-Commissioned Officer (NCO) words and recommendations to the command staff to justify and/or advance future requirements. In some example, the briefs can be given prior to in person or virtual meetings to give written read ahead. The system may be configured to generate and provide the briefs to a first group of individuals at one time and after a predetermined time period provide the briefs (original or revised) to a second group of individuals.

In step 716, preparation and/or discussions of future phases for training, exercised and/or evolutions are performed. During the KMI debriefs, identifications can be made of where KMI can support future events and/or improve support (e.g., as compared to last rounds). Supporting future events and/or improving support may not always be provided by the entity providing the service, but may provide command filling gaps and/or gain a better understanding of the requirements across the board (e.g., Intel/TSE/EW/Cyber/Etc.) Operations performed in relation to step 716 may provide for the entity providing the service to improve their image and the sell their capabilities without selling themselves on future contracts. Identifying the KMI can support future events and/or improve support may provide future clients an indication that the entity is good at what they claim to do and why.

In some examples, the review and report phase may include providing certificates of successful completion to each customer team member and/or certification for equipment used in the testing.

Within the scope of contract, changes can occur many time in given period (e.g., in a day). KMI understanding to flex and adapt to the changes and interaction with the customer at all levels throughout the process allows for the KMI to adapt to the changes effectively.

There may be no “Day 1-15″ preset” lanes and/or training to flow as is (unless exceptional and known circumstances). According to examples of the present technology, the process steps can include making adjustments to actual levels and ability of the “real” end-user/customer and/or adjust to actual level of customer technology capability.

According to examples of the present technology, a daily plan is provided but one or more training point and/or “stop” may provide for and/or require change. In some examples, every training point and/or “stop” may require an option to provide a change. Allowing for changes to be made may allow for the Business Planning Team (BPT) to have alternates and/or backups.

To improve the capabilities to make changes, KMI may be involved in backside discussions, briefs, debriefs and/or planning. If members of the KMI know what is being planned work, the process can adjust one or more lanes to meet their unadvertised daily requirement and/or expectations.

The involvement in the backside discussions, briefs, debriefs and/or planning may be not just by team lead level but on the command and/or daily group levels. The involvement may include involvement in customer chat groups to confirm locations (360 view models can assist with this), intentions, requirements, etc. and adjust training on customer movements. For example, if the exercise is being performed in the wrong area of operation (AO), intel may be given to adjust the area of operation and/or provide for more role players as needed. In addition, involvement in the backside discussions, briefs, debriefs and/or planning may reduce wasted time in limited training opportunities.

Providing for interaction with all levels of customer may allow to see training gaps from other orgs (EX: LTE training), customer thoughts and feedback on lanes and topics, identify real world situations and activities, and/or build in to provide training opportunities to support these features.

According to some examples of the present technology, missing a requirement (e.g., during the testing of equipment) on one day or during a testing period may not miss the test requirement forever. The example operations may provide for recognition if opportunity missed and provide for discussion (e.g., notification) with leadership on alternative opportunities to re-introduce without senior guidance. If senior guidance is needed, the example processes can allow for the guidance to come from senior guidance instead of the entity providing the service. Such operations may allow for the senior to become the leaders.

According to some example, the entity providing the service may also coordination efforts with local, state, and federal law enforcement agencies in the area as necessary to facilitate de-confliction with other elements potentially operating in the area and enable damage control in the event of a training mishap during any phases of the example embodiments.

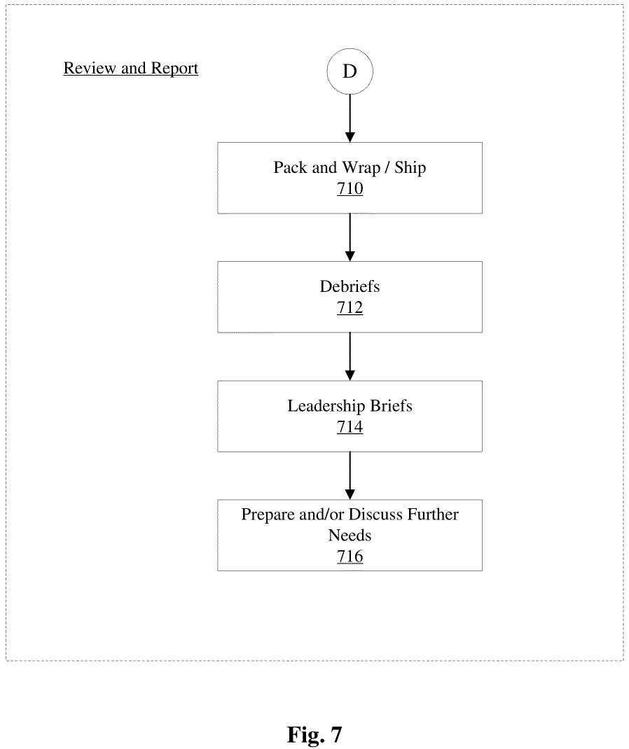

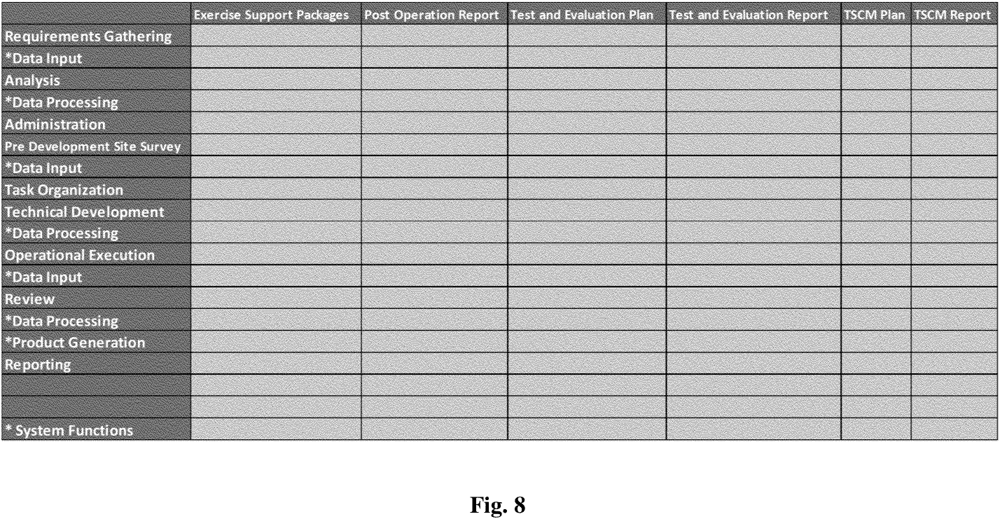

FIG. 8 is an example diagram of process flow phases and tasks that can be associated with each phase. The process flow phases shown in FIG. 8 may be associated with one or more illustrated tasks. In some examples, each of the process flow phases shown is associated with each of the tasks.

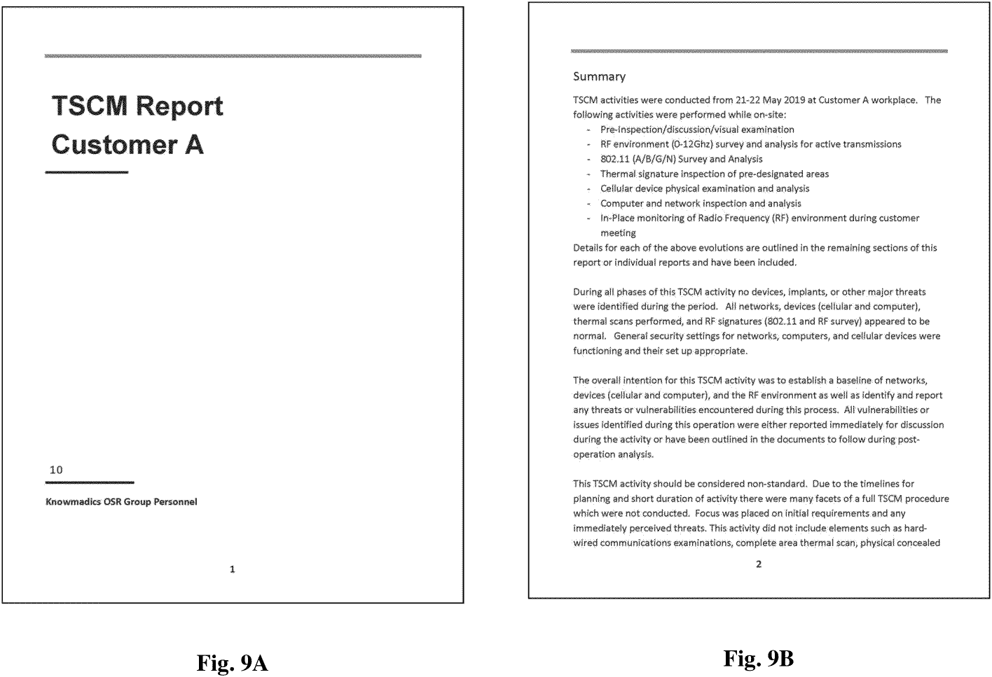

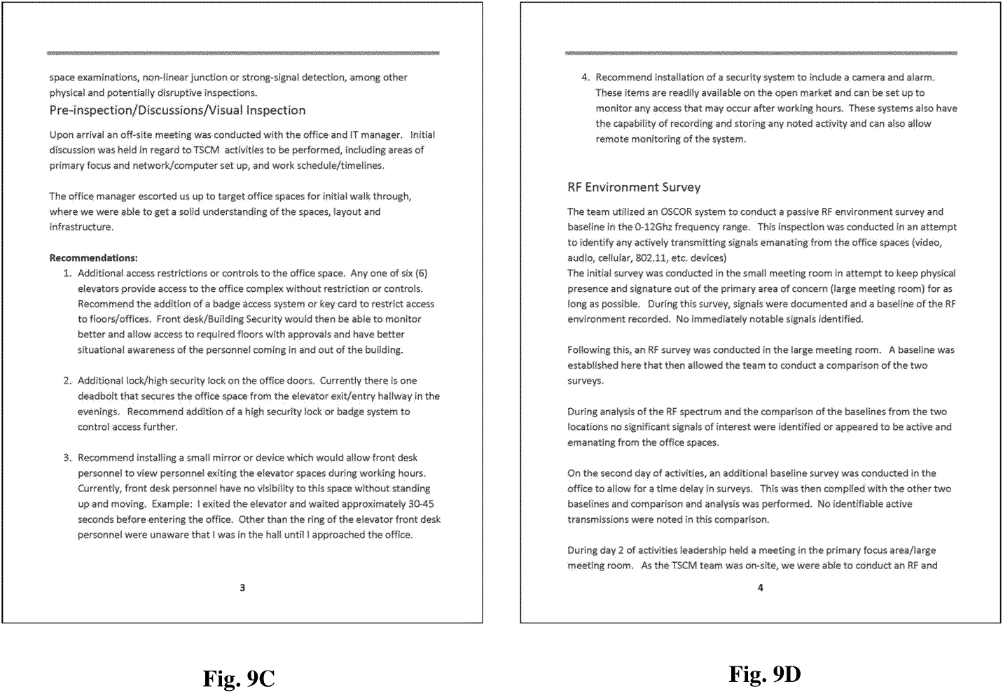

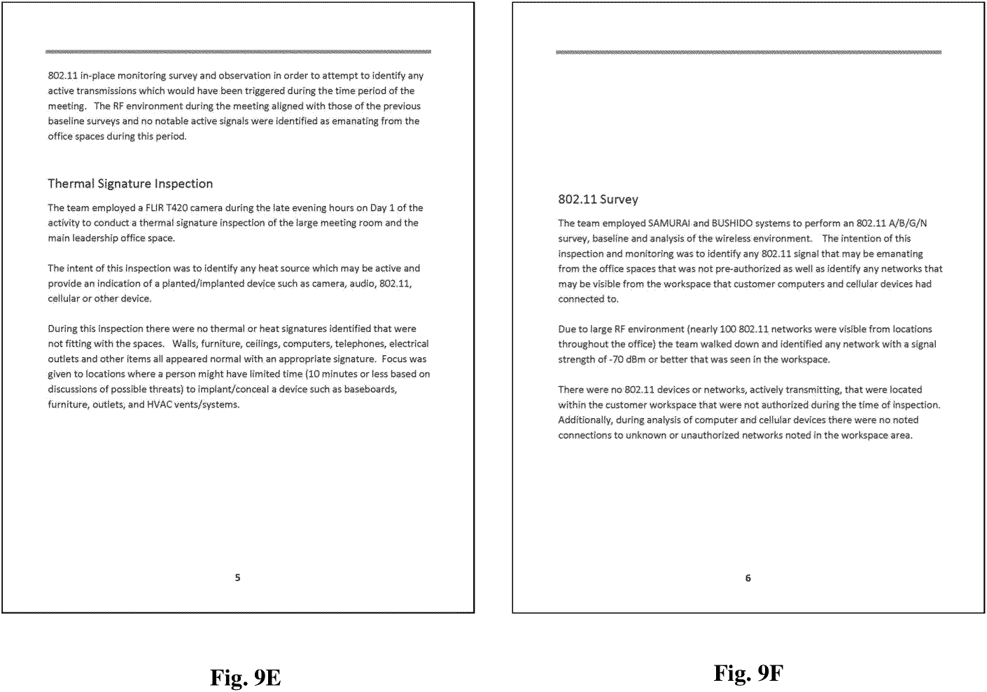

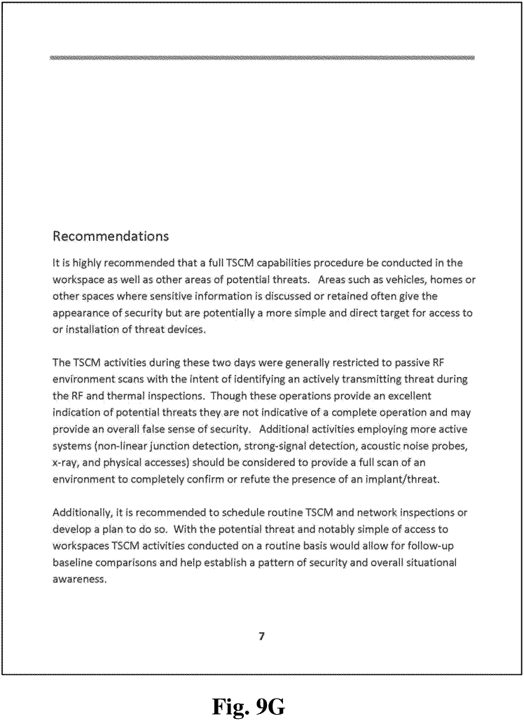

FIGS. 9A-9G illustrate an Example Technical Counter Surveillance Measures (TSCM) report for a customer accordance with certain example embodiments. The report may be generated with or without user involvement. In some examples, the system may automatically generate a template for the report based on the requirements and/or operations performed during the exercise.

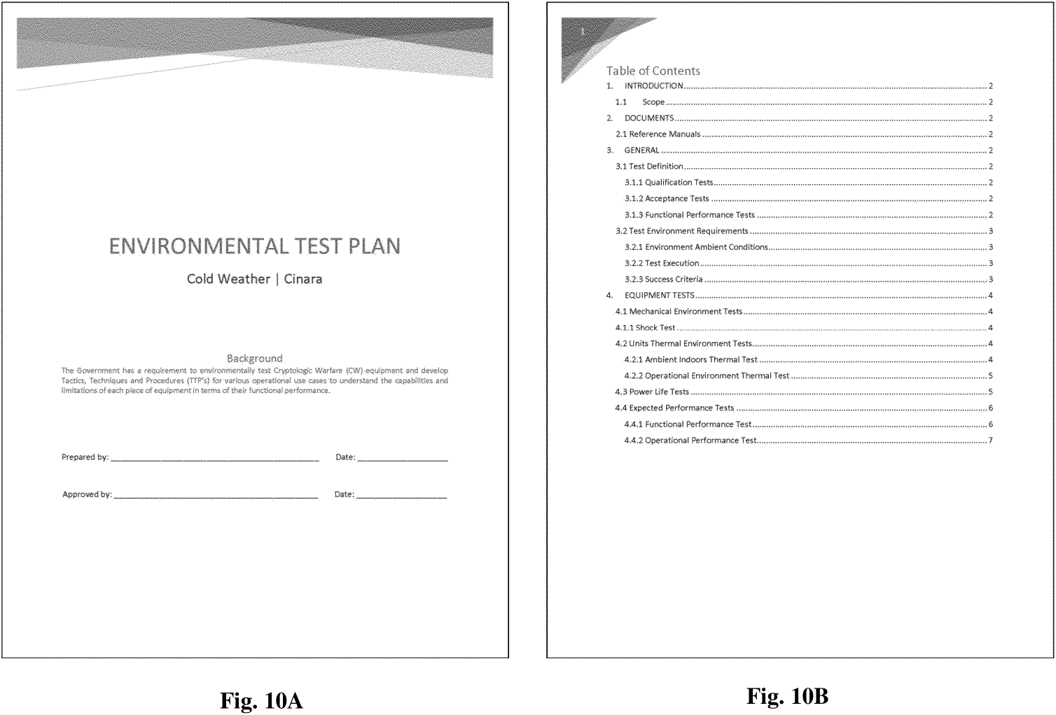

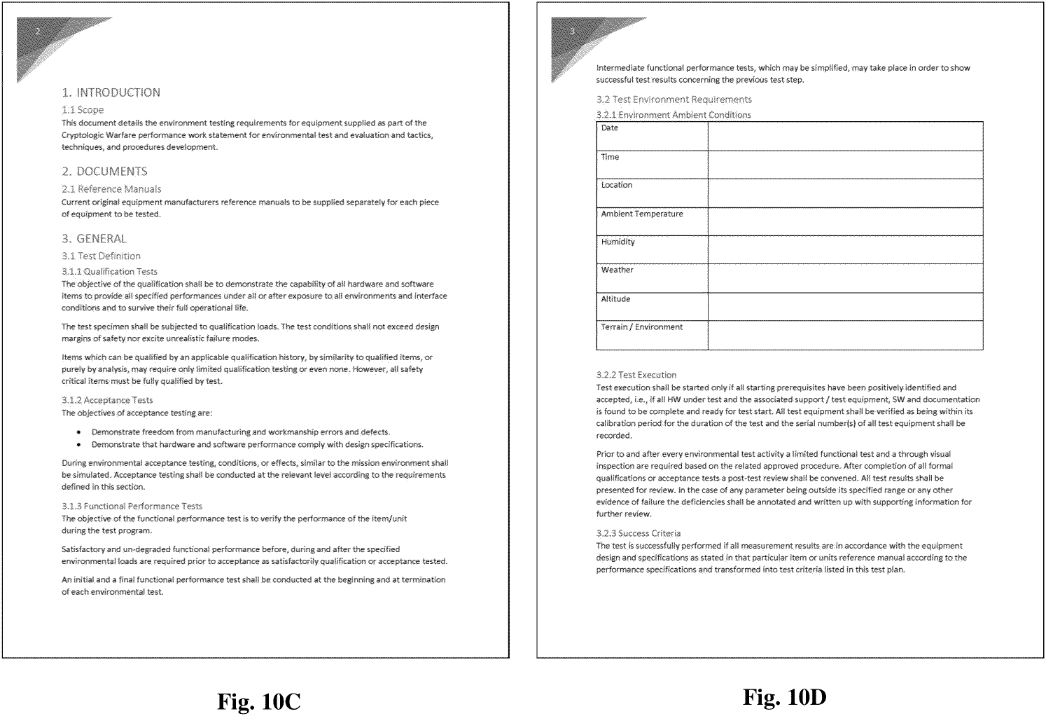

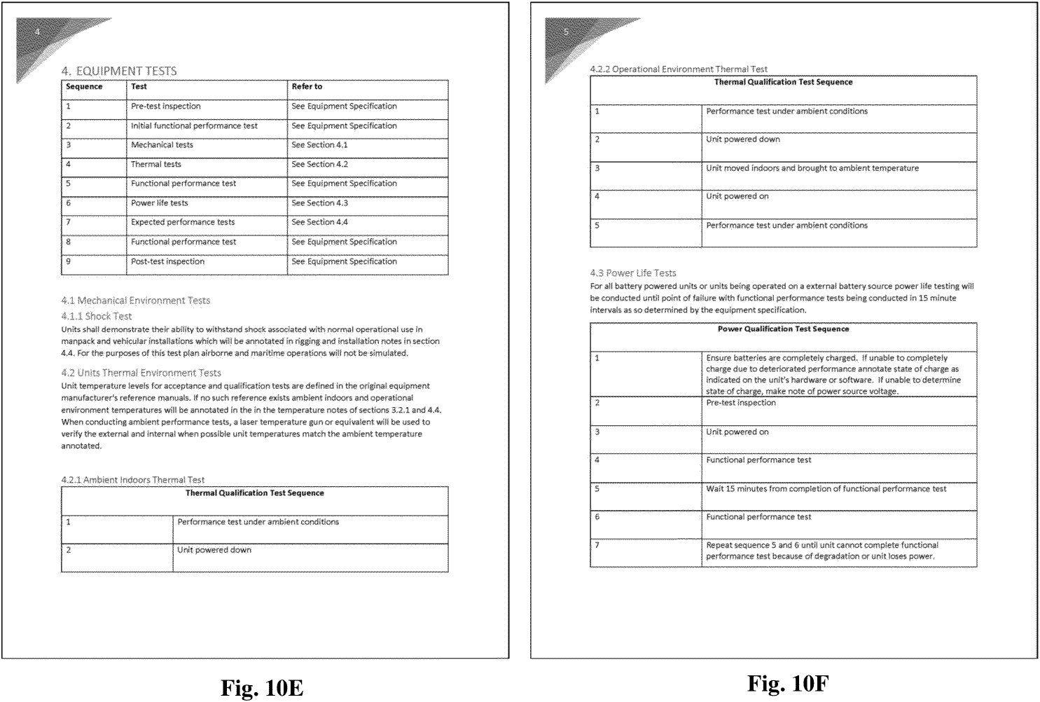

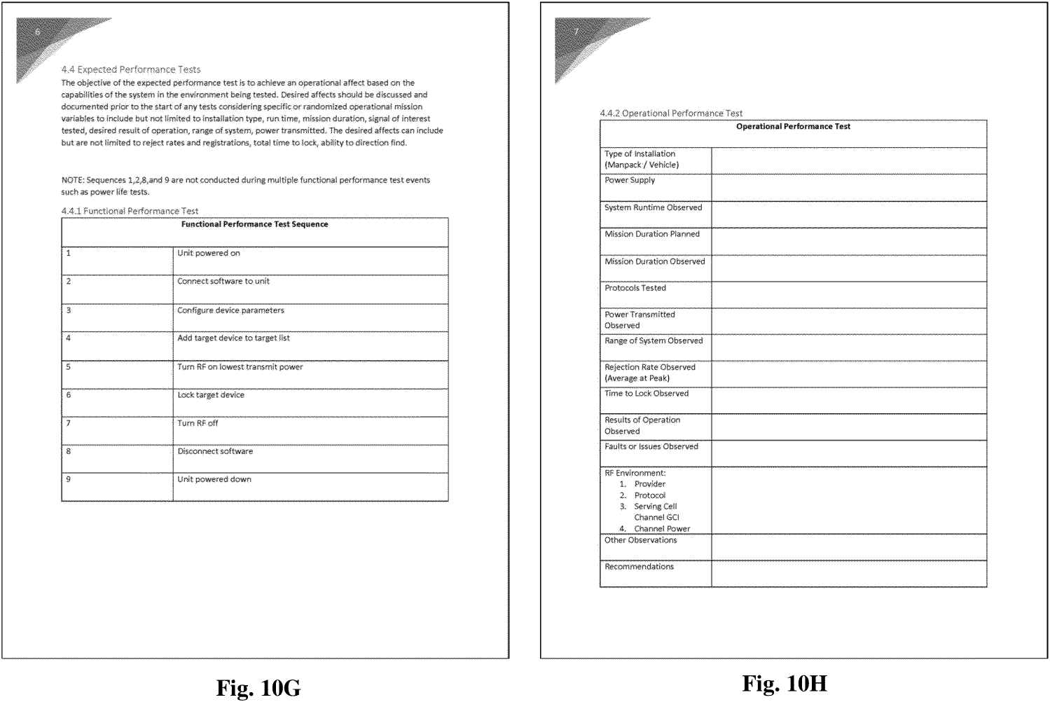

FIGS. 10A-10H illustrate an Environmental Test Plan according accordance with certain example embodiments. The report may be generated with or without user involvement. The test plan may be generated based on the requirements and/or operations performed during the exercise.

One or more operations described in this application may be performed by a processing system including one or more processors coupled to memory. In some example, the one or more processors may be a distributed system and/or include a cloud computing system. The Processing system may include hardware and/or software confirmed to perform machine learning and/or use artificial intelligence to perform one or more operations. For example, based on previous completed scenarios and results of the scenarios, one or more requirements, set up scenarios, and/or role player information may be recommended by an artificial intelligence system based on one or more trained models. The models may be trained based on previous completed scenarios and results of the scenarios. In some examples, one or more operations described in this application may be performed by or in association with an aggregation platform (e.g., 360° Aware® platform) and/or one or more devices and/or system(s) described in U.S. Pat. Application 17/843,515.

Tn aggregation platform may provide alerts and notifications, real time mapping, in app chat, live streaming, machine to machine processes for one or more operations described in this application. The alerts and notifications may provide for involved individuals to stay informed in realtime across all channels (e.g., email, SMS, mobile push notifications, and in-app activity feed). Real time mapping may provide tracking and protection of high value assets with realtime location tracking on smartphones, smart watches, GPS tracker and radios (e.g., during the operational execution). In app chat may allow for individuals to stay connected and collaborate with all key stakeholder though one-to-one, group or live event in-app chat during any of the phases described in this application. The live streaming may be used during the operational execution to provide realtime feedback from individuals being tested/trained or the role players. Machine to Machine processes may help to automate the collection of information and providing information between the system used in administering the described operations and the devices used by the individuals being tested/trained or the role players.

For example, the cloud, the enterprise service bus (ESB) and/or the server described in U.S. Pat. Application 17/843,515 may be used to collect information from different sources (e.g., requirements, cost estimates, real time data from the devices used by the role players and/or individuals being trained or tested), process the information (e.g., determine additional criteria), administer the testing, and/or provide the reporting. During one or more operations the cloud, the enterprise service bus (ESB) and/or the server may be configured to provide information for display on mobile devices as described in U.S. Pat. Application 17/843,515.

It will be appreciated that as used herein, the terms system, subsystem, service, engine, module, programmed logic circuitry, and the like may be implemented as any suitable combination of software, hardware, firmware, and/or the like. It also will be appreciated that the storage locations, stores, and repositories discussed herein may be any suitable combination of disk drive devices, memory locations, solid state drives, CD-ROMs, DVDs, tape backups, storage area network (SAN) systems, and/or any other appropriate tangible non-transitory computer readable storage medium. Cloud and/or distributed storage (e.g., using file sharing means), for instance, also may be used in certain example embodiments. It also will be appreciated that the techniques described herein may be accomplished by having at least one processor execute instructions that may be tangibly stored on a non-transitory computer readable storage medium.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for providing training, exercises and/or scenarios for conjuring technical targeting operations, the method comprising:
receiving, from one or more sources, initial requirements for one or more devices;
performing analysis and administration phase based on the received initial requirements to determine one or more detailed requirements;
performing task organization and technical development phase comprising receiving information about a plurality of role players, responsibilities of the plurality of role players, and locations for the plurality of role players;
operational execution of exercises and/or training for a plurality of participants based on the initial requirements, detailed requirements, and information received from the role players; and
reporting permeance of one or more participants.

2. The method of claim 1, wherein the initial requirements are retrieved from one or more remote databases.

3. The method of claim 1, wherein at least one initial requirement is applicable to each of the one or more devices.

4. The method of claim 1, wherein the initial requirements include performance expectations for each the device, testing conditions, and/or timing requirements.

5. The method of claim 4, wherein the testing conditions, and/or timing requirements are different for each device.

6. The method of claim 1, wherein one or more additional requirements are determined based on the initial requirements, capabilities of the one or more devices and training objectives.

7. The method of claim 1, wherein performing the analysis and administration phase includes outputting finalized requirements including the initial requirements and the detailed requirements.

8. The method of claim 1, wherein performing the task organization and technical development phase includes determination whether to approve or deny requested changes based on pre-stored criteria, information about the changes, capabilities of the role players, information about a testing environment, and information about available devices.

9. The method of claim 1, wherein further comprising, during the operational execution of exercises and/or training, receiving operations performed on devices associated with the plurality of participants.

10. The method of claim 1, wherein reporting performance of one or more participants includes identifying gaps in the performance of the one or more participants.

11. A non-transitory computer readable storage medium tangibly storing a program for providing training, exercises and/or scenarios for conjuring technical targeting operations, the program, when executed by a computing system including at least one processor, performing one or more of the functionalities comprising:
receiving, from one or more sources, initial requirements for one or more devices;
performing analysis and administration phase based on the received initial requirements to determine one or more detailed requirements;
performing task organization and technical development phase comprising receiving information about a plurality of role players, responsibilities of the plurality of role players, and locations for the plurality of role players;
operational execution of exercises and/or training for a plurality of participants based on the initial requirements, detailed requirements, and information received from the role players; and
reporting permeance of one or more participants.

12. A computing system for providing training, exercises and/or scenarios for conjuring technical targeting operations, the computing system comprising:
a memory; and
at least one processor coupled to the memory and configured to:
receive, from one or more sources, initial requirements for one or more devices;
perform analysis and administration phase based on the received initial requirements to determine one or more detailed requirements;
perform task organization and technical development phase comprising receiving information about a plurality of role players, responsibilities of the plurality of role players, and locations for the plurality of role players;
perform operational execution of exercises and/or training for a plurality of participants based on the initial requirements, detailed requirements, and information received from the role players; and
report permeance of one or more participants.

13. The system of claim 12, wherein the initial requirements are retrieved from one or more remote databases.

14. The system of claim 12, wherein at least one initial requirement is applicable to each of the one or more devices.

15. The system of claim 12, wherein the initial requirements include performance expectations for each the device, testing conditions, and/or timing requirements.

16. The system of claim 15, wherein the testing conditions, and/or timing requirements are different for each device.

17. The system of claim 12, wherein one or more additional requirements are determined based on the initial requirements, capabilities of the one or more devices and training objectives.

18. The system of claim 12, wherein performing the analysis and administration phase includes outputting finalized requirements including the initial requirements and the detailed requirements.

19. The system of claim 12, wherein performing the task organization and technical development phase includes determination whether to approve or deny requested changes based on pre-stored criteria, information about the changes, capabilities of the role players, information about a testing environment, and information about available devices.

20. The system of claim 12, wherein further comprising, during the operational execution of exercises and/or training, receiving operations performed on devices associated with the plurality of participants.

21. The system of claim 12, wherein reporting performance of one or more participants includes identifying gaps in the performance of the one or more participants.

22. The system of claim 12, further comprising communication circuitry configured to communicate with a plurality of mobile devices, and wherein the at least one processor is further configured to: transmit, during the operational execution of exercises and/or training to the plurality of mobile devices information about relation of exercise participants and mobile and static targets within a scenario of the exercises and/or training.

23. The system of claim 12, further comprising communication circuitry configured to communicate with a plurality of mobile devices, and wherein the at least one processor is further configured to: transmit to one or more of the plurality of mobile devices, during the operational execution of exercises and/or training, information about relation of exercise participants and mobile and static targets within a scenario of the exercises and/or training.

24. The system of claim 12, further comprising communication circuitry configured to communicate with a plurality of devices, and wherein the at least one processor is further configured to: transmit to one or more of the devices, during the operational execution of exercises and/or training, information about visualization of locations mapped in the scenario for viewing and situation awareness throughout the scenario.

25. The system of claim 12, wherein the at least one processor is further configured to: generate common stop analysis charts based on role player tracking activity within the system.

26. The system of claim 12, wherein the at least one processor is further configured to: generate relational activity and engagement between target sites, role players, and/or exercise participants throughout the scenario.

27. The system of claim 12, wherein the at least one processor is further configured to: generate common stop reports in relation to role players and their pattern of life movements throughout the scenario.
